(19) United States
(12) Patent Application Publication
(10) Pub. No.: US 2019/0033566 A1
(43) Pub. Date: Jan. 31, 2019

(54) OPTICAL SYSTEM INCLUDING REFRACTIVE SURFACE AND REFLECTIVE SURFACE, AND IMAGING APPARATUS AND PROJECTION APPARATUS INCLUDING THE SAME

(71) Applicant: CANON KABUSHIKI KAISHA, Tokyo (JP)

(72) Inventor: Koji Maezawa, Utsunomiya-shi (JP)

(21) Appl. No.: 16/042,921

(22) Filed: Jul. 23, 2018

(30) Foreign Application Priority Data
Jul. 26, 2017 (JP) 2017-144396

(51) Int. Cl. G02B 17/08; B60W 30/09; B60W 50/14; G06T 7/50

(52) U.S. Cl. CPC G02B 17/0836; G02B 17/0876; G02B 17/0896; B60W 2050/143; B60W 30/09; B60W 50/14; G06T 7/50; G02B 17/0856

(57) ABSTRACT

An optical system includes a first optical element including a refractive surface convex to an enlargement side, a second optical element including a catadioptric surface convex to the enlargement side, a third optical element including a reflective surface of a concave shape with respect to light incident thereon, and a fourth optical element that is a refractive element having positive power, wherein light from the enlargement side travels to a reduction side via the refractive surface, a reflective region of the catadioptric surface, the refractive surface, the reflective surface, the refractive surface, a refractive region of the catadioptric surface, and the fourth optical element in succession, and wherein a medium between the refractive surface and the reflective surface has a refractive index lower than that of the first optical element.

### BACKGROUND OF THE INVENTION

### Field of the Invention

The present invention relates to an optical system including a refractive surface and a reflective surface, and is suitable, for example, for imaging apparatuses such as a digital still camera, a digital video camera, a vehicle-mounted camera, a mobile phone camera, a monitoring camera, a wearable camera, and a medical camera, and projection apparatuses such as a projector.

### Description of the Related Art

A catadioptric optical system using a reflective surface and a refractive surface for downsizing has been known as an optical system for use in an imaging apparatus or a projection apparatus. Japanese Patent Application Laid-Open No. 2004-361777 discusses a catadioptric optical system including an optical element which includes a plurality of refractive surfaces and a plurality of reflective surfaces. Japanese Patent Application Laid-Open No. 2003-215458 discusses a catadioptric optical system including a catadioptric member which includes a rear-surface mirror portion and a lens portion, and a reflective member which includes a reflective surface.

In the catadioptric optical system discussed in Japanese Patent Application Laid-Open No. 2004-361777, all the reflective surfaces reflect light inside the optical elements. Coma aberration and lateral chromatic aberrations have therefore been difficult to correct. In the catadioptric optical system discussed in Japanese Patent Application Laid-Open NO. 2003-215458, correction of various aberrations and telecentricity is not sufficient. High image forming performance therefore has not been obtained.

### SUMMARY OF THE INVENTION

The present invention is directed to a small-sized optical system having high image forming performance

According to an aspect of the present invention, an optical system includes a first optical element including a refractive surface convex to an enlargement side, a second optical element including a catadioptric surface convex to the enlargement side, a third optical element including a reflective surface of a concave shape with respect to light incident thereon, and a fourth optical element that is a refractive element having positive power, wherein light from the enlargement side travels to a reduction side via the refractive surface, a reflective region of the catadioptric surface, the refractive surface, the reflective surface, the refractive surface, a refractive region of the catadioptric surface, and the fourth optical element in succession, and wherein a medium between the refractive surface and the reflective surface has a refractive index lower than that of the first optical element.

Further features of the present invention will become apparent from the following description of exemplary embodiments with reference to the attached drawings.

### BRIEF DESCRIPTION OF THE DRAWINGS

FIGS. 1A and 1B are schematic diagrams respectively illustrating essential parts of an optical system in a YZ section and seen from a +Y side according to a first exemplary embodiment of the present invention.

FIG. 2 illustrates longitudinal aberration charts of the optical system according to the first exemplary embodiment.

FIG. 3 illustrates lateral aberration charts of the optical system according to the first exemplary embodiment.

FIGS. 4A and 4B are schematic diagrams respectively illustrating essential parts of an optical system of YZ section and seen from the +Y side according to a second exemplary embodiment of the present invention.

FIG. 5 illustrates longitudinal aberration charts of the optical system according to the second exemplary embodiment.

FIG. 6 illustrates lateral aberration charts of the optical system according to the second exemplary embodiment.

FIG. 7 is a functional block diagram of a vehicle-mounted camera system according to an exemplary embodiment of the present invention.

FIG. 8 is a schematic diagram illustrating essential parts of a vehicle according to the exemplary embodiment.

FIG. 9 is a flowchart illustrating an operation example of the vehicle-mounted camera system according to the exemplary embodiment.

FIGS. 10A and 10B are schematic diagrams illustrating essential parts of a distance measuring optical system according to an exemplary embodiment of the present invention.

FIG. 11 is a schematic diagram illustrating essential parts of a reflective portion of the distance measuring optical system according to the exemplary embodiment.

### DESCRIPTION OF THE EMBODIMENTS

Exemplary embodiments of the present invention will be described below with reference to the drawings. For the sake of convenience, the drawings may be drawn in scales different from actual ones. In the drawings, similar members are designated by the same reference numerals, and a redundant description thereof will be omitted. In the exemplary embodiment, an “optical surface” refers to a refractive surface or a reflective surface. An “optical axis” refers to an axis that passes through the center (surface vertex) of each optical surface in an optical system. A “distance” refers to a surface-to-surface distance on an optical axis.

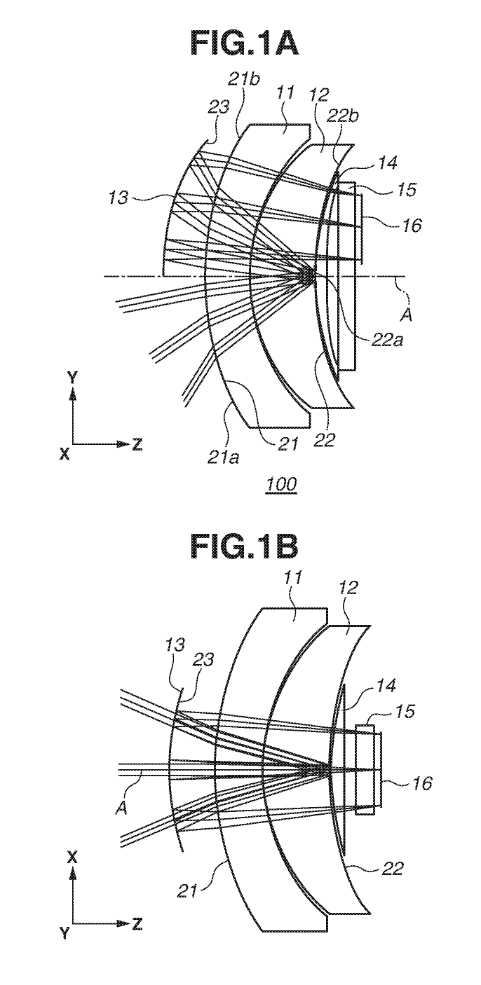

FIG. 1A is a schematic diagram illustrating essential parts in an YZ section (vertical section) including an optical axis A of an optical system 100 according to a first exemplary embodiment of the present invention. FIG. 1B is a schematic diagram illustrating the essential parts when the optical system 100 is seen from a +Y side in the Y direction (vertical direction). FIG. 1B illustrates a light beam traveling toward a center image height in the Y direction. In FIGS. 1A and 1B, the left side (−Z side) is an enlargement side. The right side (+Z side) is a reduction side. The optical system 100 according to the present exemplary embodiment is an image forming optical system for condensing a light beam from a not-illustrated object to form an image of the object. The optical system 100 can be applied to an imaging apparatus and a projection apparatus.

If the optical system 100 is applied to an imaging apparatus as an imaging optical system, a reduction plane of the optical system 100 constitutes an image plane at which an imaging surface (light reception surface) of an image sensor, such as a charge-coupled device (CCD) sensor and a complementary metal-oxide-semiconductor (CMOS) sensor, is disposed. If the optical system 100 is applied to a projection apparatus as a projection optical system, the reduction plane constitutes an object plane at which a display surface of a display element such as a liquid crystal panel (spatial modulator) is arranged. In other words, the object side and the image side are reversed and the optical path is reverse in direction between the imaging optical system and the projection optical system. In the following description, the optical system 100 is assumed to be applied to an imaging apparatus.

The optical system 100 according to the present exemplary embodiment is a catadioptric optical system including a first optical element 11, a second optical element 12, a third optical element 13, and a fourth optical element 14. The first optical element 11 includes a refractive surface 21 convex to the enlargement side (object side). The second optical element 12 includes a catadioptric surface 22 convex to the enlargement side. The third optical element 13 includes a reflective surface 23 of concave shape with respect to light incident thereon. The fourth optical element 14 is a refractive element having positive power.

Light from the enlargement side travels to the reduction side (image side) via the refractive surface 21, the catadioptric surface 22, the refractive surface 21, the reflective surface 23, the refractive surface 21, the catadioptric surface 22, and the fourth optical element 14 in this order, and is incident on an imaging surface of an image sensor 16. In such a manner, the optical system 100 achieves downsizing by folding the optical path by the catadioptric surface 22 and the reflective surface 23.

In the present exemplary embodiment, a medium between the refractive surface 21 and the reflective surface 23 has a refractive index smaller than that of the first optical element 11. Since the medium between the refractive surface 21 and the reflective surface 23 is made of a material different from that of the first optical element 11, a difference in refractive index can be produced at the interface between the medium and the refractive surface 21. This enables favorable correction of comatic aberration, lateral chromatic aberration, and distortion aberration.

The optical system 100 is configured so as to allow the light incident from the enlargement side to travel through the refractive surface 21, the catadioptric surface 22, and the reflective surface 23 before traveling through the fourth optical element 14 having positive power. In this way, the optical system 100 secures favorable telecentricity. The optical system 100 according to the present exemplary embodiment thus achieves both downsizing and high image forming performance.

An optical system 100 according to the first exemplary embodiment of the present invention will be described below. The optical system 100 according to the present exemplary embodiment employs the same configuration as that of the optical system 100 according to the above-described exemplary embodiment. A redundant description will thus be omitted.

A first optical element 11 according to the present exemplary embodiment is a refractive element (lens) including a refractive surface 21 at the enlargement side, which is an enlargement-side surface, and a refractive surface at the reduction side, which is a reduction-side surface and convex to the enlargement side. The refractive surface 21 includes a refractive region 21a through which light travels through once in this embodiment, and a refractive region 21b through which light travels through multiple times. For example, the light travels through the refractive region 21b in the exemplary embodiment as shown in FIG. 1A. The first optical element 11 has negative power.

A second optical element 12 according to the present exemplary embodiment is a catadioptric element (catadioptric lens) including a refractive surface at the enlargement side, which is an enlargement-side surface and convex to the enlargement side, and a catadioptric surface 22 at the reduction side, which is a reduction-side surface. The catadioptric surface 22 includes a reflective region 22a that reflects light and a refractive region 22b that refracts light. The refractive portion of the second optical element 12 has positive power.

The reflective region 22a according to the present exemplary embodiment includes a reflective portion, which reflects effective light contributing to image formation, and a light shielding portion, which shields other light. The reflective region 22a plays the role of an aperture stop. For example, the reflective portion includes a reflective film (vapor deposition film). For example, the light shielding portion includes a light absorbing member.

A third optical element 13 according to the present exemplary embodiment is a reflective member (mirror) including a reflective surface 23 having positive power. A fourth optical element 14 according to the present exemplary embodiment is a refractive element including a refractive surface at the enlargement side, which is an enlargement-side surface and convex to the enlargement side, and a refractive surface at the reduction side, which is a reduction-side surface and convex to the enlargement side. The reduction-side surface of the first optical element 11, the enlargement-side surface of the second optical element 12, and the refractive surfaces of the fourth optical element 14 are not limited to the above-described configuration. The directions (signs of power) of the refractive surfaces may be changed if needed.

A light beam from an object at the enlargement side is incident on the refractive region 21a of the refractive surface 21, transmitting through the reduction-side surface of the first optical element 11 and the enlargement-side surface of the second optical element 12, and reflected by the reflective portion in the reflective region 22a of the catadioptric surface 22. In this case, part of the light is shielded by the light shielding portion of the reflective region 22a.

The light reflected by the reflective portion of the reflective region 22a transmits through the enlarged-side surface of the second optical element 12 and the reduction-side surface of the first optical element 11, and is output towards the third optical element 13 from the refractive region 21b of the refractive surface 21. The light is further reflected by the reflective surface 23, incident on the refractive region 21b again, transmitting through the reduction-side surface of the first optical element 11 and the enlargement-side surface of the second optical element 12, and transmitting through the refractive region 22b of the catadioptric surface 22. The light then transmits through the fourth optical element 14 and a cover glass 15, and forms an image plane with a flat shape.

As illustrated in FIG. 1B, in the X direction (horizontal direction), the optical system 100 has a symmetrical shape with respect to the optical axis A. The light from the enlargement side is incident on the refractive surface 21 from both sides of the optical axis A. In other words, in a ZX section (horizontal section) at each position in the Y direction, the optical system 100 has a symmetrical shape with respect to the optical axis A.

In the vertical section illustrated in FIG. 1A, the first, second, and fourth optical elements 11, 12, and 14 each have a symmetrical shape with respect to the optical axis A. The third optical element 13 has an asymmetrical shape with respect to the optical axis A. In the vertical section, the light from the enlargement side is incident on the refractive surface 21 only from the lower side (−Y side) of the optical axis A, and the image plane is formed on the upper side (+Y side) of the optical axis A. In this way, the optical system 100 is configured in such a manner that, in the vertical section, the light is incident on the refractive surface 21 from only one side of the optical axis A, i.e., the light is obliquely incident on the optical surfaces.

The imaging apparatus can be configured to make the imaging surface eccentric to the optical axis A in the Y direction so that the imaging surface receives only the light beam incident on the optical system 100 from the side opposite to the imaging surface with respect to the optical axis A. A projection apparatus can be configured to make the display surface eccentric to the optical axis A in the Y direction so that the light beam from the display surface is output to the outside the optical system 100 from the side opposite to the display surface with respect to the optical axis A. This can fold the optical path, so that the image sensor or the display element can be arranged not to interfere with the optical elements or the optical paths while achieving downsizing.

An angle of view (horizontal angle of view) in the horizontal section including the optical axis A of the optical system 100 according to the present exemplary embodiment is 50°. The range of angle ex within the horizontal angle of view is −25°≤θx≤+25°, where the +X side with reference to the optical axis A (0°) is positive and the −X side negative. An angle of view (vertical angle of view) in the vertical section including the optical axis A of the optical system 100 is 46°. The range of angle ey within the vertical angle of view is −23°≤θy≤+23°, where the +Y side with reference to a ray (0°) that is incident on the refractive region 21a of the refractive surface 21 and reaches the center image height is positive and the −Y side negative.

In the optical system 100 according to the present exemplary embodiment, the horizontal angle of view is symmetrically set on both sides of the optical axis A. On the other hand, the vertical angle of view is set only on the −Y side of the optical axis A. The optical system 100 is configured in such a manner that the angle of view in the vertical section (second cross section) including the optical axis A and is perpendicular to the horizontal section (first section) is smaller than that in the horizontal section including the optical axis A.

The optical system 100 according to the present exemplary embodiment is a coaxial system in which the centers of curvature of all the optical surfaces exist on the optical axis A. The optical system 100 according to the present exemplary embodiment is also a rotationally symmetrical system in which all the optical surfaces have a rotationally symmetrical shape with respect to the optical axis A. As illustrated in FIG. 1A, the reflective surface 23 is shaped in such a manner that an unneeded portion on which no effective light is incident is cut away. However, the base surface of the reflective surface 23 has a rotationally symmetrical shape, and the surface vertex of the base surface is located on the optical axis A. Such configuration of the optical system 100 as a coaxial system and a rotationally symmetrical system enables favorable correction of aberrations in both the horizontal and vertical sections.

Table 1 illustrates specification values of the optical system 100 according to the present exemplary embodiment. In Table 1, r represents a curvature radius (mm), d represents a surface-to-surface distance (mm), Nd represents a refractive index with respect to d-line, and vd represent an Abbe number with respect to d-line. The surface-to-surface distance d is positive toward the reduction side along the optical axis, and negative toward the enlargement side. “E±N” means “×10^{±N}”.

TABLE 1
Surface data (first exemplary embodiment)

| Surface number | r | d | Nd | νd |
|---|---|---|---|---|
| 1 | 41.38 | 6.51 | 1.85 | 40.8 |
| 2 | 26.73 | 0.10 | | |
| 3 | 25.36 | 9.14 | 1.78 | 44.2 |
| 4 | ∞ | 0.00 | | |
| 5 | 34.62 | −9.14 | 1.78 | 44.2 |
| 6 | 25.36 | −0.10 | | |
| 7 | 26.73 | −6.51 | 1.85 | 40.8 |
| 8 | 41.38 | −6.82 | | |
| 9 | 32.93 | 6.82 | | |
| 10 | 41.38 | 6.51 | 1.85 | 40.8 |
| 11 | 26.73 | 0.10 | | |
| 12 | 25.36 | 9.14 | 1.78 | 44.2 |
| 13 | 34.62 | 0.30 | | |
| 14 | 38.13 | 1.74 | 1.63 | 60.1 |
| 15 | 151.64 | 1.63 | | |
| 16 | ∞ | 2.50 | 1.51 | 64.1 |
| 17 | ∞ | 1.00 | | |

Aspherical coefficients (first exemplary embodiment)

| Surface number | 1, 8, 10 | 5 | 9 | 15 |
|---|---|---|---|---|
| Curvature radius | 41.38 | 34.62 | 32.93 | 151.64 |
| Conic constant | 0 | 0 | −0.67 | 0 |
| Coefficient of fourth- | 1.33E−06 | 1.36E−05 | 2.88E−06 | −6.45E−06 |
| order term | | | | |
| Coefficient of sixth- | −4.42E−09 | −8.51E−08 | 3.15E−09 | 3.44E−07 |
| order term | | | | |
| Coefficient of eighth- | 1.98E−11 | −6.94E−10 | −9.25E−13 | −7.90E−10 |
| order term | | | | |
| Coefficient of tenth- | −5.50E−14 | 4.74E−12 | 1.70E−14 | 3.37E−13 |
| order term | | | | |
| Coefficient of | 1.43E−16 | −4.97E−15 | −4.09E−17 | 0 |
| twelfth-order term | | | | |
| Coefficient of | −1.75E−19 | 0 | 4.62E−20 | 0 |
| fourteenth-order term | | | | |

In the present exemplary embodiment, the optical surfaces of aspherical shapes each have a rotationally symmetrical shape about the optical axis A. The rotationally symmetrical shape is expressed by the following aspherical equation:

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} … .$$

In the above aspherical equation, z is a sagittal amount (mm) of the aspherical shape in the optical axis direction, c is a curvature (1/mm) on the optical axis A, k is a conic constant, r is a radial distance (mm) from the optical axis A, and A to G are the aspherical coefficients of the fourth- to sixteenth-order terms, respectively. In the foregoing aspherical equation, the first term represents the sagittal amount of the base spherical surface. The base spherical surface has a curvature radius of R=1/c. The second and subsequent terms represent the sagittal amounts (aspherical amounts) of the aspherical components added to the base spherical surface. While the present exemplary embodiment uses the aspherical coefficients of the fourth- to fourteenth-order terms, the aspherical coefficients of the sixteenth- and higher-order terms may be used.

In the present exemplary embodiment, if an optical surface has an aspherical shape, the curvature radius of its base spherical surface is used as the curvature radius of the optical surface. The curvature radius satisfies conditional expressions to be described below. If the curvature radius of the base spherical surface is difficult to be identified, the radius of paraxial curvature of the aspherical surface may be used as the curvature radius of the optical surface.

Next, characteristics of the optical elements according to the present exemplary embodiment will be described.

As described above, the light incident on the first optical element 11 is once output to the outside of the first optical element 11 from the refractive region 21b and travels toward the reflective surface 23. In the present exemplary embodiment, the medium between the refractive region 21b and the reflective surface 23 is made of a material different from that of the first optical element 11, whereby a difference in refractive index is caused between the refractive region 21b and the medium. In this way, the refractive angle of the light output from the refractive region 21b can be made equivalent to that of the light incident on the refractive region 21a, and comatic aberration, lateral chromatic aberration, and distortion aberration can be favorably corrected.

More specifically, the refractive region 21a is a refractive surface convex toward light that is incident from the enlargement side. Thus, in the refractive region 21a, light passing through a position far from the optical axis A is more refracted than light passing near the optical axis A. This makes the angles of respective rays incident on the refractive region 21a non-uniform, so that comatic aberration, lateral chromatic aberration, and distortion aberration occur. On the other hand, the refractive region 21b is a refractive surface concave toward light that is output toward the reflective surface 23. Therefore, also in the refractive region 21b, light passing through a position far from the optical axis A is more refracted than light passing near the optical axis A.

Since the reflective region 22a of the catadioptric surface 22 is arranged on the optical path between the refractive regions 21a and 21b, the arrangement of the rays in the light beam (distances from the optical axis A) is reversed between when the rays are incident on the refractive region 21a and when the rays are output from the refractive region 21b. Therefore, the optical system 100 according to the present exemplary embodiment can cancel the comatic aberration, lateral chromatic aberration, and distortion aberration occurring in the refractive region 21a by the refractive region 21b.

The following conditional expression (1) is desirably satisfied:

0.40≤N1−Nm≤1.5, (1)

wherein N1 is the refractive index of the first optical element 11 with respect to d-line, and Nm is the refractive index of the medium between the refractive surface 21 and the reflective surface 23 with respect to d-line.

The difference in refractive index between the first optical element 11 and the adjoining medium can be increased and the refractive angle of the light output from the refractive surface 21 to the outside of the first optical element 11 can be increased by satisfying the conditional expression (1). This facilitates the correction of the comatic aberration, lateral chromatic aberration, and distortion aberration. Below the lower limit value of the conditional expression (1), the difference in refractive index between the first optical element 11 and the adjoining medium is so small that the correction of the comatic aberration, lateral chromatic aberration, and distortion aberration becomes difficult. Above the upper limit value of the conditional expression (1), the difference in refractive index between the first optical element 11 and the adjoining medium is so large that the correction of other aberrations becomes difficult.

The following conditional expression (1′) is more desirably satisfied:

0.60≤N1−Nm≤1.0 (1′)

The medium between the refractive surface 21 and the reflective surface 23 is more desirably air, since air has a refractive index as extremely low as 1.00. In the present exemplary embodiment, the medium between the refractive surface 21 and the reflective surface 23 is air, the refractive index of the first optical element 11 is N1=1.85, and the difference in refractive index between the first optical element 11 and air is N1-Nm=0.85. The conditional expressions (1) and (1′) are satisfied.

The reflective region 22a according to the present exemplary embodiment is a reflective surface of convex shape as described above, and has a function as an aperture stop. The effect on field curvature and astigmatism can be suppressed and the spherical aberration can be favorably corrected by thus providing an aperture stop on the reflective region 22a having negative power. The provision of the negative power to the reflective region 22a can secure an appropriate distance between the reflective surface 23 and the image plane, and facilitates avoiding interference between the optical system 100 and the image sensor 16. In the present exemplary embodiment, the reflective region 22a is configured as an aspherical surface that decreases in power with an increasing distance from the optical axis A. This enables more favorable correction of the spherical aberration.

The reflective portion of the reflective region 22a according to the present exemplary embodiment has an elliptical shape. The major axis is parallel to the horizontal section, and the minor axis is parallel to the vertical section. In other words, the diameter of the reflective portion of the reflective region 22a in a first direction (horizontal direction) perpendicular to the optical axis A is greater than that of the reflective portion in a second direction (vertical direction) perpendicular to the optical axis A and the first direction.

In other words, the aperture value (F number) of the optical system 100 according to the present exemplary embodiment is set in such a manner that the vertical section in which the angle of view of the optical system 100 is asymmetrical with respect to the optical axis A is greater (darker) than the horizontal section in which the angle of view of the optical system 100 is symmetrical with respect to the optical axis A. This can improve brightness and resolution in the horizontal section and narrow the beam width in the vertical section to facilitate avoiding optical path interference. The degrees of freedom of arrangement of the optical surfaces can thus be improved. The shape of the reflective portion of the reflective region 22a is not limited to the elliptical shape, and may have a rectangular shape as needed.

The third optical element 13 according to the present exemplary embodiment is an element for mainly correcting field curvature. In general, to correct field curvature in an optical system, an optical design is made to reduce the Petzval sum of the optical surfaces by mutual cancellation of positive power and negative power, so that the Petzval image plane approaches a flat plane. On the other hand, the optical system 100 according to the present exemplary embodiment corrects field curvature by setting an appropriate sagittal amount for the reflective surface 23 of the third optical element 13. A detailed description thereof is given below.

The optical system 100 according to the present exemplary embodiment has positive power as a whole. Therefore, Petzval image plane in forming an image near the image plane tends to have a curved shape displaced toward the enlargement side from the optical axis A to the peripheral portion. On the other hand, the reflective surface 23 has a concave shape, i.e., a shape displaced toward the reduction side from the optical axis A to the peripheral portion. Thus, the distance between the reflective surface 23 and the image plane decreases from the optical axis A to the peripheral portion.

Therefore, the field curvature caused by the optical system 100 can be favorably corrected by cancelling the field curvature with optical path differences at respective image heights, caused by the sagittal amount of the reflective surface 23. Since the reflective surface 23 is configured as an aspherical surface, the field curvature not fully corrected by only the base spherical surface of the reflective surface 23 can be further corrected by the aspherical components of the reflective surface 23. This can improve the degrees of design freedom of the sagittal amount of the reflective surface 23 and enables more favorable correction of the field curvature.

To correct field curvature occurring in an optical system, an aspherical surface is typically configured to have lower power in the peripheral portion than on the optical axis. On the other hand, according to the present exemplary embodiment, unlike a typical optical system, the field curvature is corrected by the sagittal amount of the reflective surface 23. Accordingly, the aspherical amount of the reflective surface 23 is designed so as to increase the power in the peripheral portion compared with the power on the optical axis A.

The following conditional expression (2) is desirably satisfied:

1.3≤Rm/|Lm|≤4.0, (2)

where Rm (mm) is the curvature radius of the reflective surface 23, and Lm (mm) is the distance between the reflective region 22a (aperture stop) and the reflective surface 23.

The interference between the image sensor or display element arranged on the image plane and the optical path can be avoided and the field curvature can be favorably corrected by satisfying the conditional expression (2). Below the lower limit value of the conditional expression (2), the possibility of interference of the image sensor or display element arranged on the image plane with the optical path increases. Above the upper limit value of the conditional expression (2), the correction of the field curvature is insufficient and favorable image forming performance is difficult to obtain.

The following conditional expression (2′) is desirably be further satisfied:

1.4≤Rm/|Lm|≤2.0 (2′)

In the present exemplary embodiment, the absolute value of the curvature radius of the reflective surface 23 is Rm=32.9, and the absolute value of the distance between the reflective region 22a and the reflective surface 23 is |Lm|=22.6. Since Rm/|Lm|=1.46, the conditional expressions (2) and (2′) are satisfied.

As describe above, various aberrations can be cancelled between the light incident on the refractive region 21a and the light output from the refractive region 21b. However, lateral chromatic aberration also occurs when the light reflected by the reflective surface 23 is incident on the refractive region 21b again. In the present exemplary embodiment, the lateral chromatic aberration is favorably corrected by the fourth optical element 14. More specifically, the lateral chromatic aberration caused by the first optical element 11 of negative power is cancelled by lateral chromatic aberration caused by the fourth optical element 14 of positive power.

In this case, the lateral chromatic aberration can be more favorably corrected by setting the Abbe number of the fourth optical element 14 to be greater than that of the first optical element 11. The distortion aberration caused by the reflective surface 23 can be more favorably corrected by configuring, as an aspherical surface, the reduction-side surface of the fourth optical element 14, which is the optical surface (final surface) arranged closest to the reduction side in the optical system 100.

The optical system 100 desirably satisfies the following conditional expression (3):

La/f≤3.0, (3)

where La is an overall length, and f is the focal length of the entire optical system 100. The optical system 100 can be downsized by reducing the overall length normalized by the focal length of the optical system 100 so that the conditional expression (3) is satisfied. The “overall length” of the optical system 100 according to the present exemplary embodiment refers to the distance between the optical surface farthest from the image plane and the image plane in the optical axis direction (Z direction). In other words, in the present exemplary embodiment, the distance between the reflective surface 23 and the image plane is the overall length of the optical system 100.

The following conditional expression (3′) is more desirably satisfied:

La/f≤2.7 (3′)

In the optical system 100 according to the present exemplary embodiment, the overall length La=29.8 mm, and the focal length f=12.1 mm. Since La/f=2.46, the conditional expressions (3) and (3′) are satisfied.

Table 2 illustrates the values of the conditional expressions (1) to (3) about the optical system 100 according to the present exemplary embodiment.

TABLE 2
Conditional expressions (first exemplary embodiment)

| | |
|---|---|
| (1) Nl − Nm | 0.85 |
| (2) Rm/\|Lm\| | 1.46 |
| (3) La/f | 2.46 |

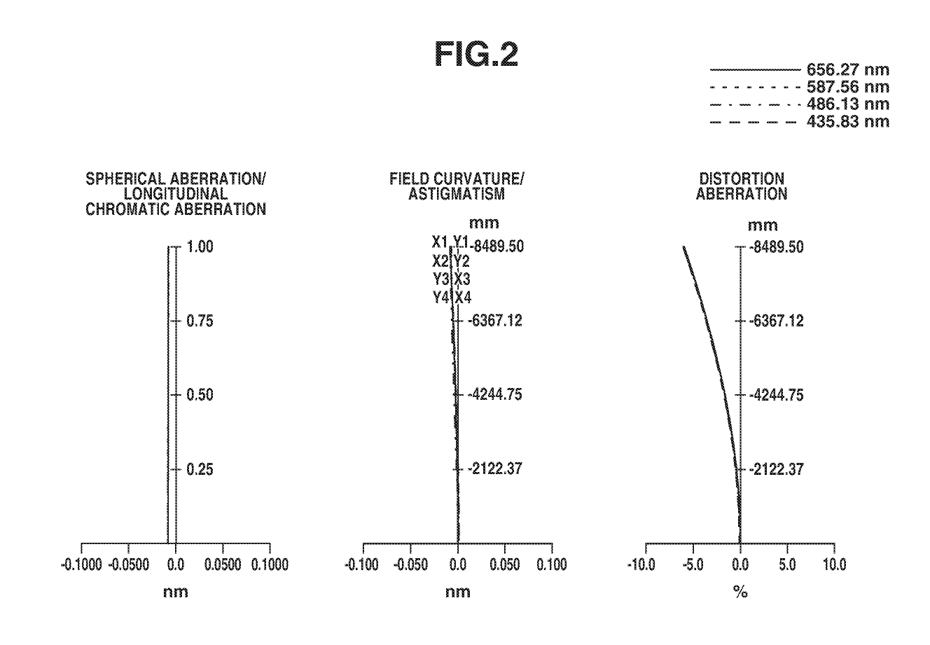

FIG. 2 illustrates longitudinal aberration charts of the optical system 100 according to the present exemplary embodiment. FIG. 2 illustrates the spherical aberration and longitudinal chromatic aberration, the field curvature and astigmatism in the horizontal and vertical directions, and the distortion aberration. The solid line in FIG. 2 represents C-line (656.27 nm in wavelength), the dotted line represents d-line (587.56 nm in wavelength), the two dotted dashed line represents F-line (486.13 nm in wavelength), and the broken line represents g-line (435.83 nm in wavelength). In the chart of the spherical aberration and longitudinal chromatic aberration, and the chart of the field curvature and astigmatism, the horizontal axis indicates a defocus amount. In the chart of the field curvature and astigmatism, and the chart of the distortion aberration, the vertical axis indicates an object height.

As can be seen from FIG. 2, the spherical aberration is 0.001 mm and the longitudinal chromatic aberration (a difference between the maximum and minimum values of each of the C-, d-, F-, and g-lines) is 0.001 mm, both of which are favorably corrected. The maximum value (absolute value) of the field curvature in the horizontal direction is 0.009 mm and the maximum value of the field curvature in the vertical direction is 0.009 mm. The astigmatism is also favorably corrected. The distortion aberration has a maximum value of approximately −8%, which is favorably corrected.

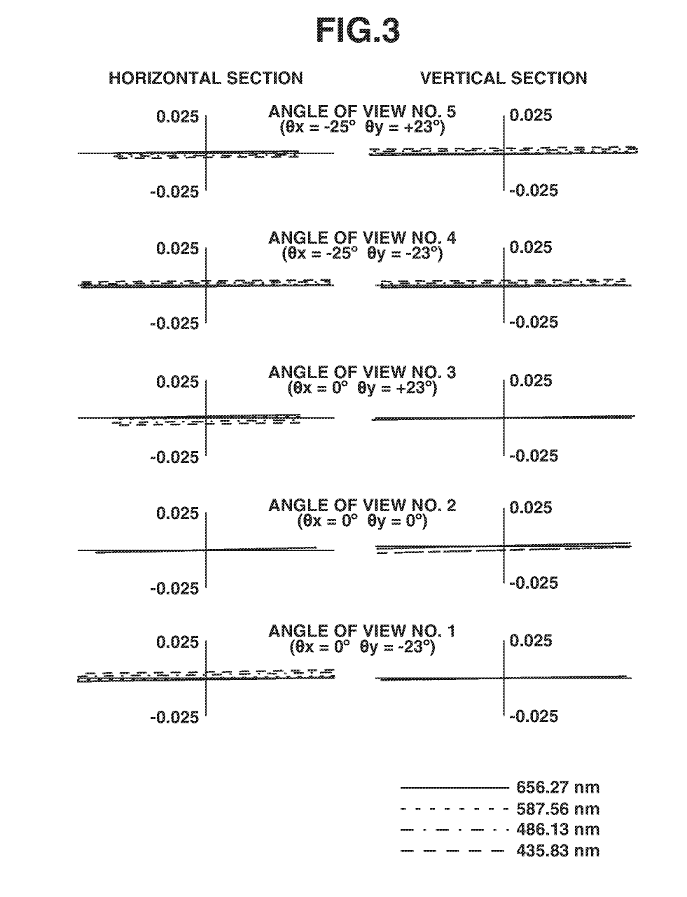

FIG. 3 illustrates lateral aberration charts of the optical system 100 according to the present exemplary embodiment. FIG. 3 illustrates lateral aberrations of the optical system 100 with respect to each of C-, d-, F-, and g-lines at five angles of view. As can be seen from FIG. 3, both the comatic aberration and the lateral chromatic aberration are favorably corrected. The optical system 100 is substantially telecentric on the image side, with an aperture ratio (vignetting) of 100% over the entire angle of view. An optical system that is bright on and off the optical axis can thus be achieved with no vignetting from the reflective region 22a.

As described above, according to the optical system 100 of the present exemplary embodiment, a small-sized optical system having high image forming performance can be achieved.

An optical system 200 according to a second exemplary embodiment of the present invention will be described below. In the optical system 200 according to the present exemplary embodiment, a description of components similar to those of the optical system 100 according to the above-described first exemplary embodiment will be omitted.

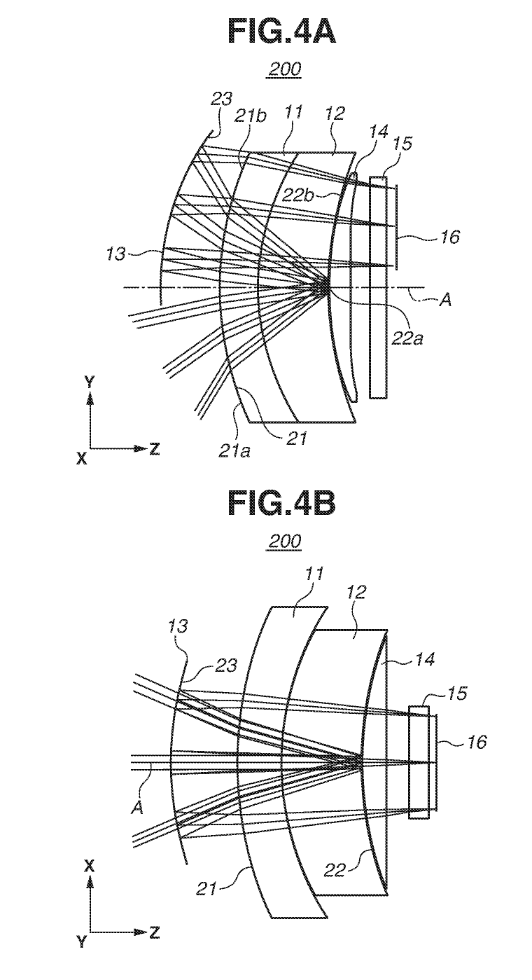

FIG. 4A is a schematic diagram illustrating essential parts of the optical system 200 in a YZ section including an optical axis A according to the present exemplary embodiment. FIG. 4B is a schematic diagram illustrating the essential parts of the optical system 200 as seen from a +Y side in the Y direction. The optical system 200 according to the present exemplary embodiment differs from the optical system 100 according to the first exemplary embodiment in that the first and second optical elements 11 and 12 are cemented. A drop in image forming performance due to deviations in relative position between optical elements can be suppressed by cementing the first and second optical elements 11 and 12.

Table 3 illustrates specification values of the optical system 200 according to the present exemplary embodiment.

TABLE 3
Surface data (second exemplary embodiment)

| Surface number | r | d | Nd | νd |
|---|---|---|---|---|
| 1 | 46.08 | 5.57 | 1.80 | 34.9 |
| 2 | 34.52 | 10.30 | 1.73 | 40.5 |
| 3 | ∞ | 0.00 | | |
| 4 | 42.03 | −10.30 | 1.73 | 40.5 |
| 5 | 34.52 | −5.57 | 1.80 | 34.9 |
| 6 | 46.08 | −9.15 | | |
| 7 | 38.43 | 9.15 | | |
| 8 | 46.08 | 5.57 | 1.80 | 34.9 |
| 9 | 34.52 | 10.30 | 1.73 | 40.5 |
| 10 | 42.03 | 0.10 | | |
| 11 | 42.03 | 3.18 | 1.48 | 70.2 |
| 12 | −647.25 | 2.79 | | |
| 16 | ∞ | 2.50 | 1.51 | 64.1 |
| 17 | ∞ | 1.00 | | |

Aspherical coefficients (second exemplary embodiment)

| Surface number | 1, 6, 8 | 4 | 7 | 12 |
|---|---|---|---|---|
| Curvature radius | 46.08 | 42.03 | 38.43 | 151.64 |
| Conic constant | 0 | 0 | −0.6731 | 0 |
| Coefficient of fourth- | 1.33E−06 | 1.36E−05 | 2.88E−06 | −6.45E−06 |
| order term | | | | |
| Coefficient of sixth- | −4.42E−09 | −8.51E−08 | 3.15E−09 | 3.44E−07 |
| order term | | | | |
| Coefficient of eighth- | 1.98E−11 | −6.94E−10 | −9.25E−13 | −7.90E−10 |
| order term | | | | |
| Coefficient of tenth- | −5.50E−14 | 4.74E−12 | 1.70E−14 | 3.37E−13 |
| order term | | | | |
| Coefficient of | 1.43E−16 | −4.97E−15 | −4.09E−17 | 0 |
| twelfth-order term | | | | |
| Coefficient of | −1.75E−19 | 0 | 4.62E−20 | 0 |
| fourteenth-order term | | | | |

The optical system 200 according to the present exemplary embodiment has an overall length of La=34.6 mm, a focal length of f=14.1 mm, a horizontal angle of view of 50°, and a vertical angle of view of 46°. As illustrated in the following Table 4, the optical system 200 satisfies the foregoing conditional expressions (1) to (3′).

TABLE 4
Conditional expressions (second exemplary embodiment)

| | |
|---|---|
| (1) Nl − Nm | 0.8 |
| (2) Rm/\|Lm\| | 1.54 |
| (3) La/f | 2.45 |

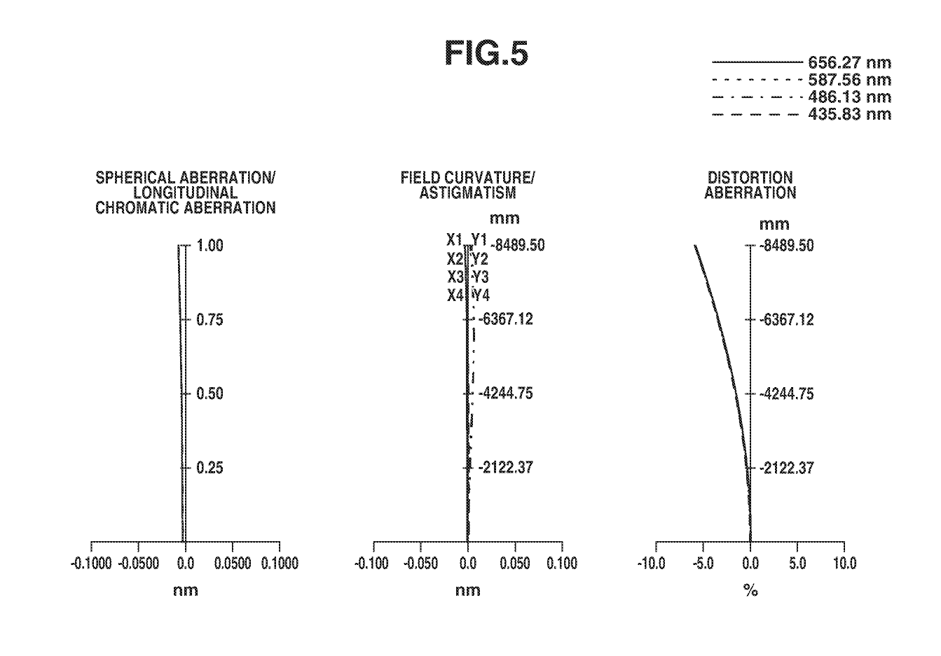

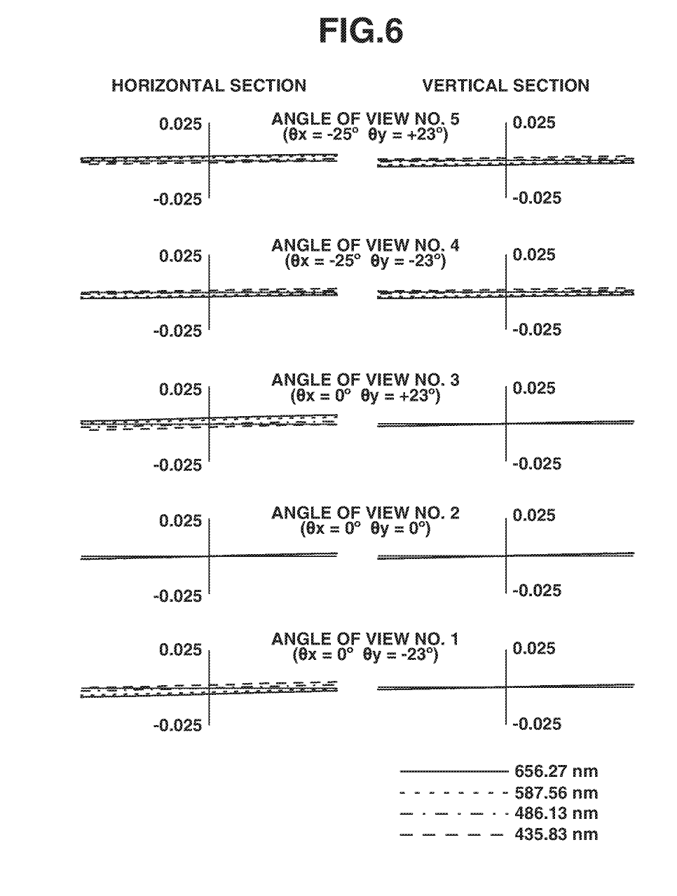

FIG. 5 illustrates longitudinal aberration charts of the optical system 200 according to the present exemplary embodiment. The spherical aberration is 0.001 mm and the longitudinal chromatic aberration is 0.001 mm, both of which are favorably corrected. The maximum value (absolute value) of the field curvature in the horizontal direction is 0.004 mm and the maximum value of the field curvature in the vertical direction is 0.002 mm. The astigmatism is also favorably corrected. The distortion aberration has a maximum value of approximately −6%, which is favorably corrected. FIG. 6 illustrates lateral aberration charts of the optical system 200. As can be seen from the lateral aberration charts, the comatic aberration and the lateral chromatic aberration are also favorably corrected. The optical system 200 is substantially telecentric on the image side, with an aperture ratio of 100% over the entire angle of view. It is shown that an optical system that is bright on and off the optical axis can be achieved.

### <Projection Apparatus>

If the optical system according to each of the above-described exemplary embodiments is applied to a projection apparatus as an projection optical system, the display surface of a display element such as a liquid crystal panel (spatial modulator) is arranged at a position of the reduction plane of the optical system. If the optical system is applied to a projection apparatus, the object side and the image side are reversed to reverse the optical path in direction. More specifically, the optical system can be configured in such a manner that an image displayed on the display surface (reduction plane) of the display element arranged on the object side is projected (formed) by the optical system on the projection surface (enlargement plane) of a screen arranged on the image side. Even in such a case, like when the optical system is applied to the imaging apparatus, the conditional expressions (1) to (3′) in the exemplary embodiments are desirably satisfied.

### <Vehicle-Mounted Camera System>

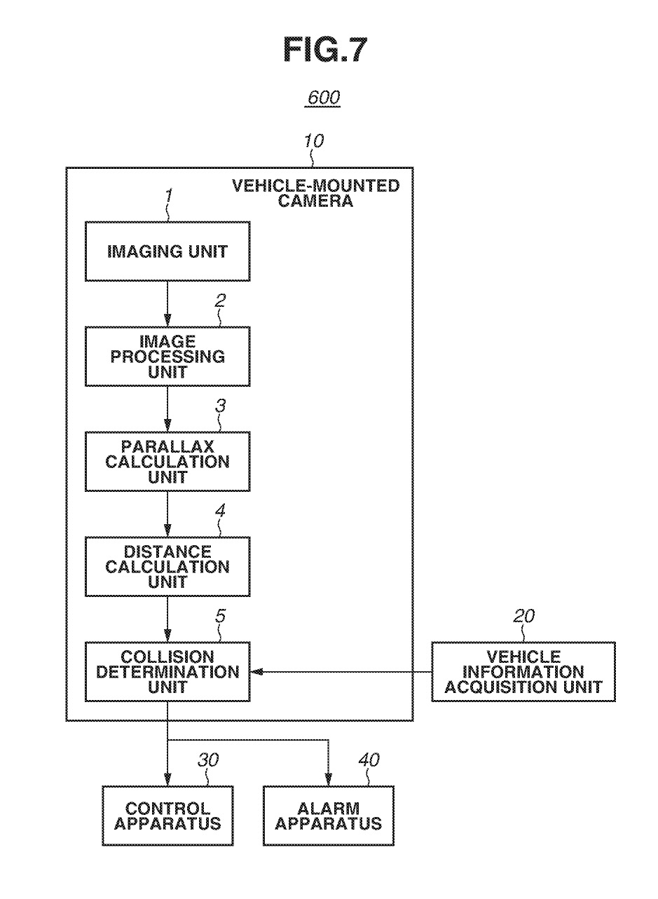

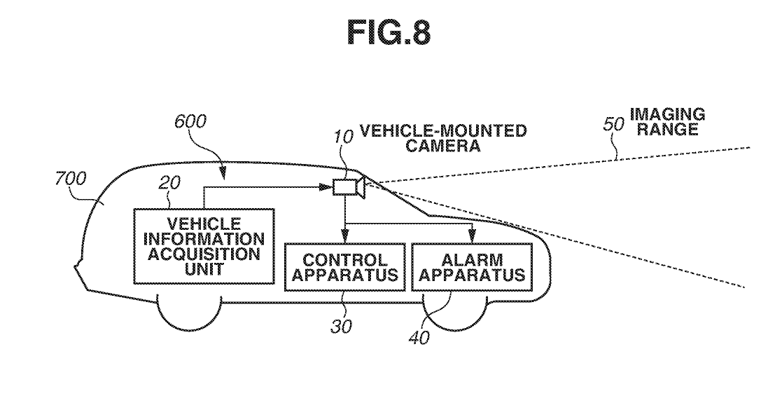

FIG. 7 is a block diagram of a vehicle-mounted camera 10 according to the present exemplary embodiment and a vehicle-mounted camera system (driving assist apparatus) 600 including the vehicle-mounted camera 10. The vehicle-mounted camera system 600 is an apparatus installed on a vehicle, such as an automobile, and intended to assist driving of the vehicle based on image information about the surroundings of the vehicle, obtained by the vehicle-mounted camera 10. FIG. 8 is a schematic diagram illustrating a vehicle 700 including the vehicle-mounted camera system 600. FIG. 8 illustrates a case where an imaging range 50 of the vehicle-mounted camera 10 is set in front of the vehicle 700. However, the imaging range 50 may be set behind the vehicle 700.

As illustrated in FIG. 7, the vehicle-mounted camera system 600 includes the vehicle-mounted camera 10, a vehicle information acquisition apparatus 20, a control apparatus (electronic control unit (ECU)) 30, and an alarm apparatus 40. The vehicle-mounted camera 10 includes an imaging unit 1, an image processing unit 2, a parallax calculation unit 3, a distance calculation unit 4, and a collision determination unit 5. The image processing unit 2, the parallax calculation unit 3, the distance calculation unit 4, and the collision determination unit 5 constitute a processing unit. The imaging unit 1 includes an optical system according to any one of the above-described exemplary embodiments, and an imaging plane phase difference sensor. For example, the imaging plane phase difference sensor according to the present exemplary embodiment corresponds to the image sensor 16 illustrated in FIG. 1.

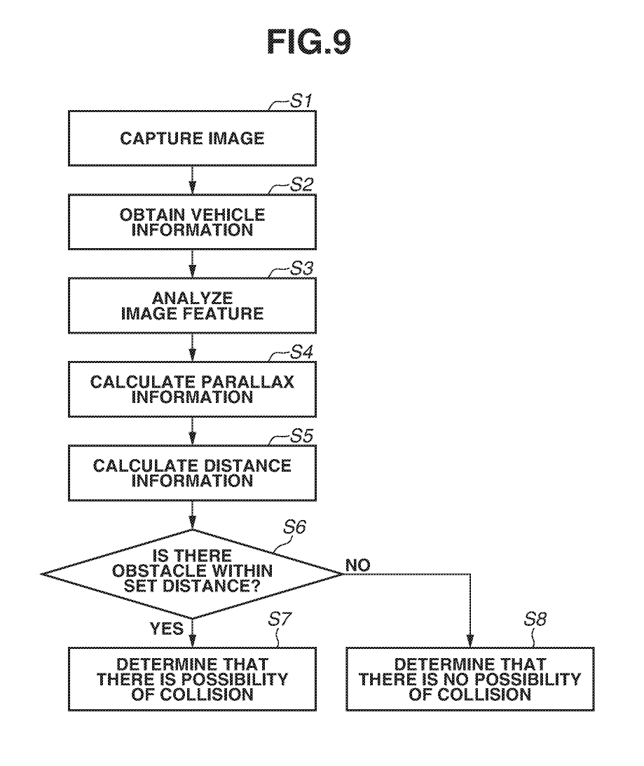

FIG. 9 is a flowchart illustrating an operation example of the vehicle-mounted camera system 600 according to the present exemplary embodiment. An operation of the vehicle-mounted camera system 600 will be described below with reference to the flowchart.

In step S1, the imaging unit 1 captures an image of objects around the vehicle, and obtains a plurality of pieces of image data (parallax image data).

In step S2, the vehicle-mounted camera 10 obtains vehicle information from the vehicle information acquisition unit 20. The vehicle information is information including the vehicle speed, yaw rate, and steering angle of the vehicle.

In step S3, the image processing unit 2 performs image processing on the plurality of pieces of image data obtained by the imaging unit 1. Specifically, the image processing unit 2 performs an image feature analysis for analyzing feature amounts of the image data, such as amounts and directions of edges and density values. The image feature analysis may be performed on each of the plurality of pieces of image data or on only some of the plurality of pieces of image data.

In step S4, the parallax calculation unit 3 calculates parallax (image shift) information between the plurality of pieces of image data obtained by the imaging unit 1. As a method for calculating the parallax information, conventional methods such as a sequential similarity detection algorithm (SSDA) method and an area correlation method may be used. In the present exemplary embodiment, a description of the method is thus omitted. The processing of steps S2, S3, and S4 may be performed in this order, or may be performed in parallel.

In step S5, the distance calculation unit 4 calculates distance information about the objects imaged by the imaging unit 1. The distance information can be calculated based on the parallax information calculated by the parallax calculation unit 3, and internal and external parameters of the imaging unit 1. As employed herein, distance information refers to information about a relative position with respect to an object. Examples of the distance information include a distance to the object, a defocus amount, and the image shift amount. Distance information may directly indicate a distance value of an object in an image, or indirectly indicate information corresponding to the distance value.

In step S6, the collision determination unit 5 determines whether the distance information calculated by the distance calculation unit 4 falls within the range of a set distance set in advance. Through this determination, the collision determination unit 5 can determine whether there is an obstacle within the set distance around the vehicle, and determine the possibility of collision between the vehicle and the obstacle. If there is an obstacle within the set distance (YES in step S6), the processing proceeds to step S7. In step S7, the collision determination unit 5 determines that there is a possibility of collision. If there is no obstacle within the set distance (NO in step S6), the processing proceeds to step S8. In step S8, the collision determination unit 5 determines that there is no possibility of collision.

In step S7, when the collision determination unit 5 determines that there is a possibility of collision (YES in step S6), the collision determination unit 5 notifies the control apparatus 30 and the alarm apparatus 40 of the determination result. The control apparatus 30 controls the vehicle based on the determination result of the collision determination unit 5. The alarm apparatus 40 issues an alarm based on the determination result of the collision determination unit 5.

For example, the control apparatus 30 performs, on the vehicle, controls such as applying the brakes, releasing the accelerator, and generating a control signal for generating braking force on each wheel to suppress engine or motor output. The alarm apparatus 40 warns the user (driver) of the vehicle, for example, by issuing an alarm sound, displaying alarm information on the screen of a car navigation system, and/or vibrating the seat belt or steering wheel.

As described above, according to the vehicle-mounted camera system 600 of the present exemplary embodiment, obstacles can be effectively detected and collision of the vehicle with the obstacles can be avoided by the above-described processing. In particular, if the optical system according to each of the above-described exemplary embodiments is applied to the vehicle-mounted camera system 600, the entire vehicle-mounted camera 10 can be downsized to enhance the degrees of freedom of layout and can also perform obstacle detection and collision determination over a wide angle of view.

In the present exemplary embodiment, the vehicle-mounted camera 10 is described to include only one imaging unit 1 that includes an imaging plane phase difference sensor.

However, this is not restrictive, and a stereo camera including two imaging units may be employed as the vehicle-mounted camera 10. In such a case, processing similar to the foregoing can be performed by simultaneously obtaining image data by the two synchronized imaging units and using the two pieces of image data, without an imaging plane phase difference sensor. If a difference between the imaging times of the two imaging units is known in advance, the two imaging units do not need to be synchronized.

There are various exemplary embodiments for the calculation of the distance information. As an example, a case where a pupil division image sensor including a plurality of pixel units regularly arranged in a two-dimensional array is employed as the image sensor included in the imaging unit 1 will be described. In the pupil division image sensor, one pixel unit includes a microlens and a plurality of photoelectric conversion units. The pixel unit can receive a pair of light beams passing through different regions of a pupil of the optical system, and output a pair of pieces of image data from the respective photoelectric conversion units.

The image shift amount in each region is then calculated by correlation calculation between the pair of pieces of image data, and the distance calculation unit 4 calculates image shift map data indicating the distribution of the amounts of image shift. Alternatively, the display calculation unit 4 may further convert the amounts of image shift into defocus amounts, and generate defocus map data indicating the distribution of the defocus amounts (distribution on the two-dimensional plane of the captured image). The distance calculation unit 4 may obtain distance map data about distances to the objects, converted from the defocus amounts.

In the present exemplary embodiment, the vehicle-mounted camera system 600 is applied to driving assistance (collision damage reduction). However, this is not restrictive, and the vehicle-mounted camera system 600 may be applied to a cruise control (including one with a full-speed following function) and automatic driving. The vehicle-mounted camera system 600 is not limited to a vehicle such as an automobile, and may be applied to a moving body (moving apparatus) such as a ship, an aircraft, and an industrial robot. The vehicle-mounted camera 10 according to the present exemplary embodiment is not limited to a moving body, and may be widely applied to equipment that uses object recognition. Examples thereof include an intelligent transport system (ITS).

### <Distance Measuring Apparatus>

A case where the optical system according to each of the above-described exemplary embodiments is applied, as a distance measuring optical system, to a distance measuring apparatus such as a vehicle-mounted camera will be described in detail below.

As described above, the vertical angle of view of the optical system according to each exemplary embodiment is set only on one side of the optical axis A. If the optical system is applied to the vehicle-mounted camera 10 and the vehicle-mounted camera 10 is installed on a vehicle, the optical system is therefore desirably arranged in such a manner that its optical axis A is not parallel to the horizontal direction.

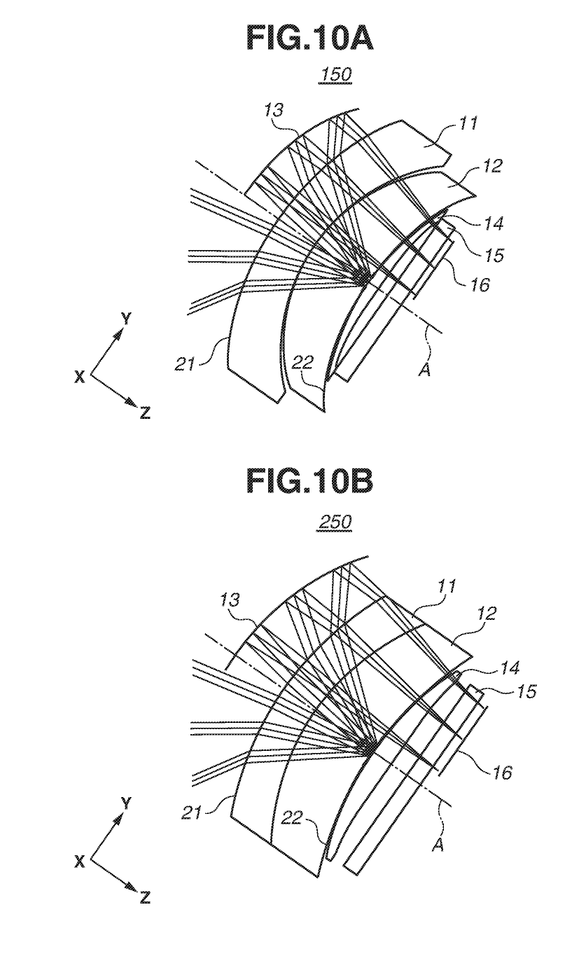

For example, if the optical system according to each of the above-described exemplary embodiments is employed as a distance measuring optical system, as illustrated in FIGS. 10A and 10B, the optical system may be arranged to tilt the optical axis A upward with respect to the horizontal direction so that the center of the vertical angle of view approaches the horizontal direction. FIGS. 10A and 10B illustrate distance measuring optical systems 150 and 250, which are the optical system 100 according to the first exemplary embodiment and the optical system 200 according to the second exemplary embodiment with their optical axis A tilted by 35° with respect to the horizontal direction. The optical systems 100 and 200 each may be rotated 180° about the X-axis (vertically inverted) and arranged so that the optical axis A tilts downward with respect to the horizontal axis. In such a manner, the imaging range of the vehicle-mounted camera 10 can be appropriately set.

In the optical system according to each exemplary embodiment, the image forming performance is highest on the optical axis A. By comparison, the image forming performance decreases at peripheral angles of view. Thus, the optical system is desirably arranged so that light from an object of intended passes near the optical axis A of the optical system. For example, if the vehicle-mounted camera 10 needs to focus on signs and obstacles on the road, the image forming performance at angles of view below the horizontal direction (ground side) is desirably enhanced, compared to that at angles of view above (sky side). In such a case, if the optical system according to each exemplary embodiment is used, the optical system may be once vertically inverted as described above and then arranged in such a manner that the optical axis A tilts downward with respect to the horizontal direction and the angle of view near the optical axis A faces the lower side.

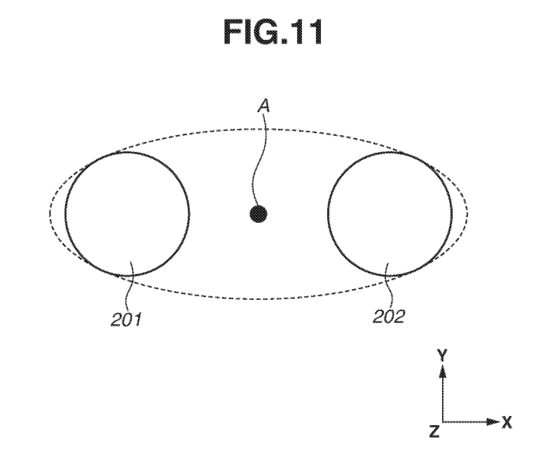

FIG. 11 is a schematic diagram illustrating essential parts of the optical system when the optical system according to each exemplary embodiment is employed as a distance measuring optical system, and the reflective portion of the reflective region 22a of the catadioptric surface 22 is seen from a −Z side in the Z direction. In FIG. 11, the solid lines represent the reflective portions of the reflective regions 22a of the distance measuring optical systems 150 and 250. The broken lines represent the reflective portions of the reflective regions 22a of the optical systems 100 and 200 according to the first and second exemplary embodiments.

As illustrated in FIG. 11, the reflective regions 22a of the distance measuring optical systems 150 and 250 each include two reflective portions 201 and 202 which are eccentric in the X direction with respect to the optical axis A. The two reflective portions 201 and 202 can divide the pupil of the distance measuring optical systems 150 and 250. The reflective portions 201 and 202 are formed of a reflection film as in the exemplary embodiments. The reflective portions 201 and 202 of each of the distance measuring optical systems 150 and 250 each have an aperture value of 8.0 in both the X direction and the Y direction.

Suppose that the distance measuring optical system 150 or 250 with a two-partitioned pupil is employed. In such a case, an image sensor that can photoelectrically convert an object image formed by the light beam that has passed the reflective portion 201 and an object image formed by the light beam that has passed the reflective portion 202 separately is employed as the image sensor 16 arranged on the image plane. Such an image sensor 16, the distance measuring optical system 150 or 250, and the foregoing processing unit can constitute a distance measuring apparatus such as a vehicle-mounted camera.

If there is an object on the front focal plane of the distance measuring optical system 150 or 250, the images formed by the two divided light beams cause no positional shift on the image plane of the distance measuring optical system 150 or 250. If there is an object at a position other than the front focal plane of the distance measuring optical system 150 or 250, the images formed by the two divided light beams cause a positional shift therebetween. Since the positional shift between the images formed by the light beams corresponds to the amount of displacement of the object from the front focal plane, the distance to the object can be measured by obtaining the amount of the positional shift between the images formed by the light beams and the direction of the positional shift.

Aberrations can be favorably corrected and high distance measurement accuracy can be achieved by configuring the optical elements of the distance measuring optical systems 150 and 250 as in the above-described exemplary embodiments. The distance measuring optical systems 150 and 250 have an aperture ratio of 100% over the entire angle of view. Therefore, stable distance measurement accuracy can be ensured over the entire angle of view by applying the distance measurement optical systems 150 or 250 to a distance measuring apparatus.

While the two reflective portions 201 and 202 of each of the distance measuring optical systems 150 and 250 are eccentric in the X direction, the reflective portions 201 and 202 may be made eccentric in the Y direction if needed. However, to improve the distance measurement accuracy, the two reflective portions 201 and 202 are desirably eccentric in the X direction. The reason is that the optical systems 100 and 200 to which the two reflective portions 201 and 202 are not applied have a smaller aperture value in the X direction in which the optical systems 100 and 200 are symmetrical with respect to the optical axis A than in the Y direction in which the optical systems 100 and 200 are asymmetrical about the optical axis A.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-144396, filed Jul. 26, 2017, which is hereby incorporated by reference herein in its entirety.

What is claimed is:

1. An optical system comprising:
a first optical element including a refractive surface convex to an enlargement side;
a second optical element including a catadioptric surface convex to the enlargement side, the catadioptric surface including a refractive region and a reflective region;
a third optical element including a reflective surface of a concave shape with respect to light incident thereon; and
a fourth optical element that is a refractive element having positive power,
wherein light from the enlargement side travels to a reduction side via the refractive surface, the reflective region, the refractive surface, the reflective surface, the refractive surface, the refractive region, and the fourth optical element in succession, and
wherein a medium between the refractive surface and the reflective surface has a refractive index lower than that of the first optical element.

2. The optical system according to claim 1, wherein the following conditional expression is satisfied:
0.40≤N1−Nm≤1.5,
where N1 is a refractive index of the first optical element with respect to d-line, and Nm is a refractive index of the medium between the refractive surface and the reflective surface with respect to d-line.

3. The optical system according to claim 1, wherein the reflective region includes a light shielding portion configured to shield part of the light.

4. The optical system according to claim 3, wherein the following conditional expression is satisfied:
1.3≤Rm/|Lm|≤4.0,
where Rm is a curvature radius of the reflective surface, and Lm is a distance between the reflective region and the reflective surface.

5. The optical system according to claim 1, wherein the following conditional expression is satisfied:
La/f≤3.0,
where La is an overall length of the optical system, and f is a focal length of the entire optical system.

6. The optical system according to claim 1, wherein the first optical element is a refractive element having negative power.

7. The optical system according to claim 1, wherein the second optical element includes a refractive surface convex to the enlargement side.

8. The optical system according to claim 1, wherein the first optical element and the second optical element are cemented to each other.

9. The optical system according to claim 1, wherein the first optical element, the second optical element, and the fourth optical element are rotationally symmetrical about an optical axis.

10. The optical system according to claim 1, wherein centers of curvature of the refractive surface and the catadioptric surface are positioned on an optical axis.

11. The optical system according to claim 10, wherein a center of curvature of the reflective surface is positioned on the optical axis.

12. The optical system according to claim 1, wherein the medium between the refractive surface and the reflective surface is air.

13. The optical system according to claim 1, wherein the first optical element has an Abbe number smaller than that of the fourth optical element.

14. An imaging apparatus comprising:
an image sensor configured to capture an image of an object; and
an optical system configured to form the image of the object on an imaging surface of the image sensor,
wherein the optical system is the optical system according to claim 1.

15. A distance measuring apparatus comprising:
an imaging apparatus configured to obtain image data concerning an object; and
a distance calculation unit configured to obtain distance information about the object based on the image data,
wherein the imaging apparatus is the imaging apparatus according to claim 14.

16. A vehicle-mounted camera system comprising:
the distance measuring apparatus according to claim 15; and
a collision determination unit configured to determine a possibility of collision between an own vehicle and the object based on the distance information.

17. The vehicle-mounted camera system according to claim 16, further comprising a control apparatus configured to, if the possibility of collision between the own vehicle and the object is determined to exist, output a control signal for generating braking force on each wheel of the own vehicle.

18. The vehicle-mounted camera system according to claim 16, further comprising an alarm apparatus configured to, if the possibility of collision between the own vehicle and the object is determined to exist, issue an alarm to a driver of the own vehicle.

19. A projection apparatus comprising:
a display element configured to display an image; and
an optical system configured to form the image on a display surface of the display element,
wherein the optical system is the optical system according to claim 1.
